(19) United States
(12) Patent Application Publication
(10) Pub. No.: US 2005/0165886 A1
(43) Pub. Date: Jul. 28, 2005

(54) Method and system for thin client based intelligent transportation

(76) Inventors: Kevin L Tuer, Ontario (CA); David Wang, Ontario (CA)

Correspondence Address: PEARNE & GORDON LLP, 1801 EAST 9TH STREET, SUITE 1200, CLEVELAND, OH, 44114-3108, US

(21) Appl. No.: 10/503,700

(22) PCT Filed: Feb. 4, 2003
(86) PCT No.: PCT/CA03/00156

(30) Foreign Application Priority Data
Feb. 5, 2002 (CA) 2370580

(51) Int. Cl. G06F 15/16

(52) U.S. Cl. 709/203

(57) ABSTRACT

A thin client based intelligent transportation system includes a server that coordinates the data flow and functionality of a data network, a plurality of clients implementing the controls generated by the server, and a communication infrastructure for interconnecting the modules of the system. A platform is installed in each client, which provides real time control capabilities with the modules of the clients. The platform may be installed in a server. The system may include a geographic information system (GIS) containing data on the local geographic infrastructure and a global positioning system (GPS) providing data to allow the clients and the server, to compute their location data and to synchronize events.

### FIELD OF THE INVENTION

The present invention relates to an intelligent thin client method and system, more specifically to a method and system in which an intelligent transportation system is developed using a thin client premise in a server-client network architecture.

### BACKGROUND OF THE INVENTION

The majority of emerging electronic innovations in the automotive industry is thick client based. An example is an adaptive cruise control (ACC) system. Existing ACCs require that a radar unit be mounted in the grill of the vehicle to detect the distance between the vehicle and any obstacles in front of it. The ACC uses this information to retain a safe following distance at a target speed. In the thick client based system, a significant amount of intelligence and hardware is installed in a client side to enable the application. As the intelligence and hardware are installed in each vehicle in the ACC system, the ACC system may cause a life cycle mismatch between the vehicle and installed electronics. For avoiding this mismatch, it is necessary to upgrade each vehicle's application and/or firmware separately.

The area of automotive telematics is relatively new. Currently, the majority of the technology is thick client based; one reason being the communications infrastructure is not yet mature enough to enable real time applications. This shortfall is being dealt with the roll out of third generation (3G) and fourth generation (4G) communications technology. The original equipment manufactures (OEMs) will need to absorb the cost of the telematics platform and associated electronics in client nodes in order to retain brand loyalty. Therefore, any technology that will reduce per unit costs will translate to more profitability for the OEM.

It is therefore desirable to provide a new method and system based on a thin client, server-client architecture in which the majority of the system and application intelligence reside on the server and is implemented by a client or multiple clients connected to the server over a network.

### SUMMARY OF THE INVENTION

It is an object of the present invention to provide a new method and system that obviates or mitigates at least one of the disadvantages of existing systems.

In accordance with an aspect of the present invention, there is provided an intelligent thin client system which includes a server for coordinating data flow and functionality of a data network, which is a host for application software; a plurality of thin clients, each of which implements a control decision generated by the server to a device to which the system is connected; and a communication network for interconnecting the system and services. Each of the thin clients includes a platform that integrates real time control of components of the thin clients and may also include capabilities that compensate for network time delay, which can drastically compromise the performance of the device being controlled via the client.

In accordance with a further aspect of the present invention, there is provided a method of implementing an intelligent thin client in a system. The system includes a server coordinating data flow and functionality of a data network, a plurality of thin clients, each of which implements a control decision generated by the server to a device to which the system is connected, and a communication network for interconnecting the system and services. Each of the thin clients includes a platform as described above. The method includes the steps of establishing synchronization between the thin clients; in the server, generating a control decision; providing the control decision to the thin client; implementing the control decision using the platform; in the platform and integrating real time control of components of the thin clients. The method may include the step of compensating for network time delay.

The system uses a thin client based infrastructure and a server controls the client through a network. The server and/or the clients have access to a number of services including the Global Positioning System (GPS), Geographic Information Systems (GIS) and other services reachable by network giving it the ability to control or influence the control of vehicles within its infrastructure in an intelligent manner. Using the thin client premise, the majority of the application and operational intelligence resides on the server. As a result, the hardware and computing requirements on the client side are minimised leading to cost savings and a reduced mismatch in lifecycles between the client platform and the vehicle in which it is installed.

Other aspects and features of the present invention will be readily apparent to those skilled in the art from a view of the following detailed description of preferred embodiments in conjunction with the accompanying drawings.

### BRIEF DESCRIPTION OF THE DRAWINGS

The invention will be well understood by the following description with reference to the drawings in which:

FIG. 1 is a schematic diagram of a thin client based intelligent transportation system in accordance with an embodiment of the invention;

FIG. 2 is a schematic diagram showing one example of an application of the system shown in FIG. 1;

FIG. 3 is a schematic diagram showing one example of a hard real time control centre (HTRCC);

FIG. 4 is a schematic diagram showing one example of the thin client based intelligent transportation system of FIG. 1;

FIG. 5 shows a schematic diagram showing one example of device interconnectivity of a host vehicle on which the client is installed;

FIG. 6 shows a sample implementation of the embodiment of the present invention;

FIG. 7 is a schematic diagram showing one example of the interconnectivity of the client and other entities within a network from the perspective of the client;

FIG. 8 is a schematic diagram showing one example of an internal real time control loop (IRTCL);

FIG. 9 is a schematic diagram showing one example of an external real time control loop (ERTCL);

FIG. 10 is a flow chart showing one example of a thin client based speed limiter for an automobile; and

FIG. 11 is a schematic diagram showing one example of an infrastructure of a geographic information system (GIS).

### DETAILED DESCRIPTION OF THE PREFERRED EMBODIMENT(S)

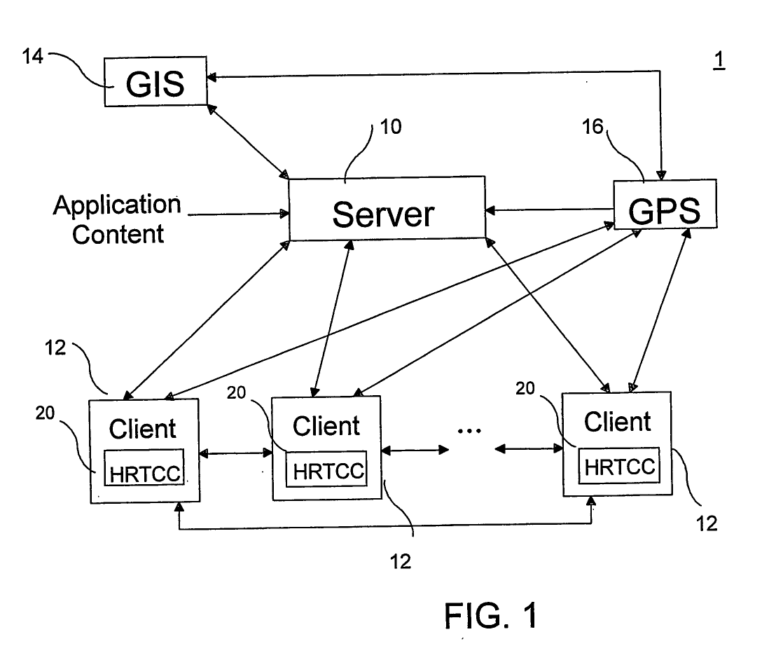

FIG. 1 shows a schematic diagram showing a thin client based intelligent transportation system 1 in accordance with an embodiment of the invention. A thin client based intelligent transportation system 1 of FIG. 1 includes a server 10, a plurality of clients 12, a Geographic Information System (GIS) 14 and a Global Positioning System (GPS) 16.

The server 10 is responsible for coordinating the data flow and functionality of a data network. The server 10 is a host for the application software of the system 1. The majority of the intelligence required to implement applications at the client level resides on the server 10. As described below, the server issues control signals to the client 12 using an ERTCL method and issues reference signals to the client using an IRTCL method.

The client 12 communicates with the server 10 to enable functionality. The client 12 also communicates with server 10 and other clients for multi-client applications.

Each client 12 includes a platform 20, referred to as a hard real time control centre (HRTCC). The HRTCC 20 may be installed in the server 10.

The GIS 14 contains information on geographic infrastructure, e.g. roads, flight paths, signage, obstacles, lanes, shoulders, waterways. The server 10 uses this information to provide warning, active control, and information services to the client 12. The information of the GIS 14 may be provided to the client 12 directly or to the client 12 via the server 10.

The GPS 16 provides data to allow the client 12 and the server 10 to compute their locations and to synchronize events. The GPS 16 may be a differential GPS (DGPS). The GPS 16 provides a mechanism by which infrastructure is identified and entered into the GIS 14.

The server 10 communicates with the modules of the system 1, e.g. client 12, GIS 14 and GPS 16, via a wireless connection, such as satellite, cellular, FM sub-carrier. The communication may also be done through a wired link.

Data is exchanged between the modules of the system 1. Data exchanged may include telemetry data, synchronization data, control signals (continuous or discrete), upgrade information, force control signals or data from information or entertainment services.

Data transmissions may be secured with encryption, depending on the nature of the information that is exchanged between the modules. For example, a vehicle in which the client 12 is installed may be controlled using encrypted control decisions from the server 10 for security purposes. This prevents other parties from tapping in and taking over the control of the vehicle.

The thin client premise in the embodiment of the present invention is that a minimum amount of hardware/software/firmware is installed in the client 12 and the majority of the intelligence resides on the server 10. The server 10 offloads data processing for the applications from the client 12.

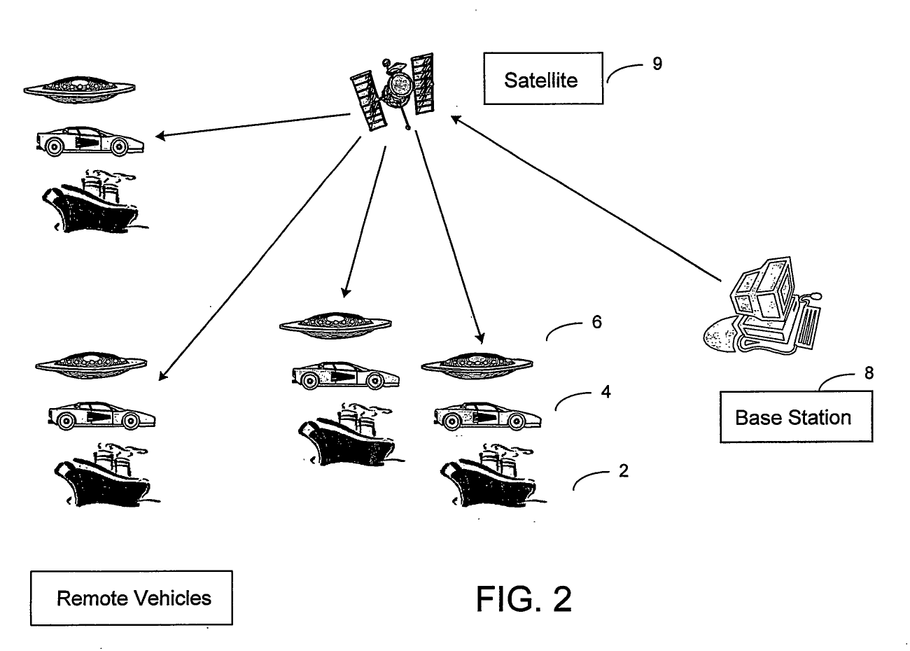

For example, the system 1 is applicable to any application whereby a vehicle or a series of vehicles are to be steered and/or controlled over the wireless network as shown in FIG. 2. In FIG. 2, the client 12 is installed in sea, ground and aerospace vehicles 2-6. The server 10, which is installed in a base station 8, may provide control decisions and any information services to the vehicles 2-5 via a wireless network, e.g. a satellite link 9.

Signal propagation between the vehicle and the server 10 may involve time delays. Additional delays due to encryption may also be involved. The HRTCC 20 can be used to solve this time delay problem.

The HRTCC 20 of FIG. 1 is now described in detail. The HRTCC 20 has functionality of implementing real time control loops. The HRTCC 20 has the ability to deploy time delay compensation technology to improve safety and performance of the real-time control loops for those applications for which network latency is an issue. The real time control loop is implemented in either an external or internal fashion to facilitate remote or local control of a client in real time using the time delay compensation capabilities of the HRTCC 20. Using the real time control loop, information is transferred between the server and clients to enable the functionality/application corresponding to this information.

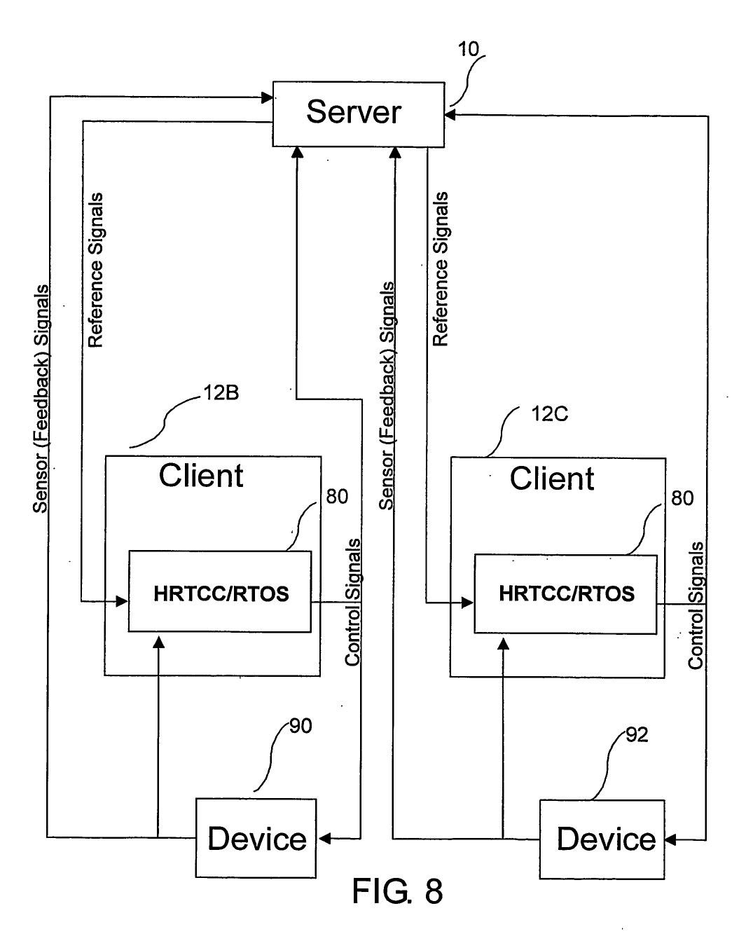

The internal real time control loop (IRTCL) is a real time control loop (FIG. 8) that is closed on a client 12 independent of the server 10 and other clients. In the case of the IRTCL, the control of the device in which the client 12 is installed is performed locally.

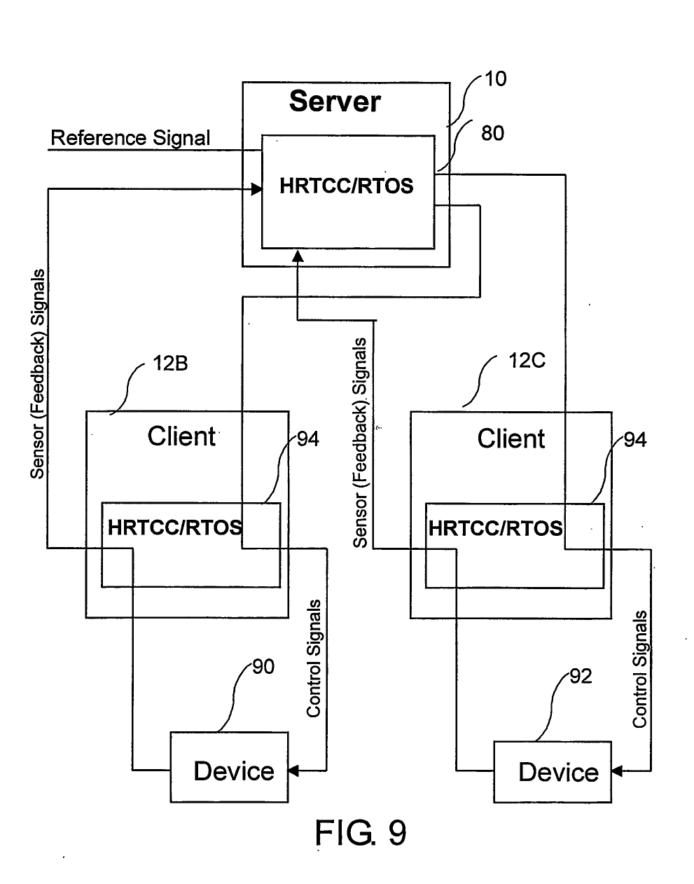

The external real time control loop (ERTCL) is a real time control loop that is closed between two or more clients through the server (FIG. 9). In the case of the ERTCL, the control is closed via the server 10.

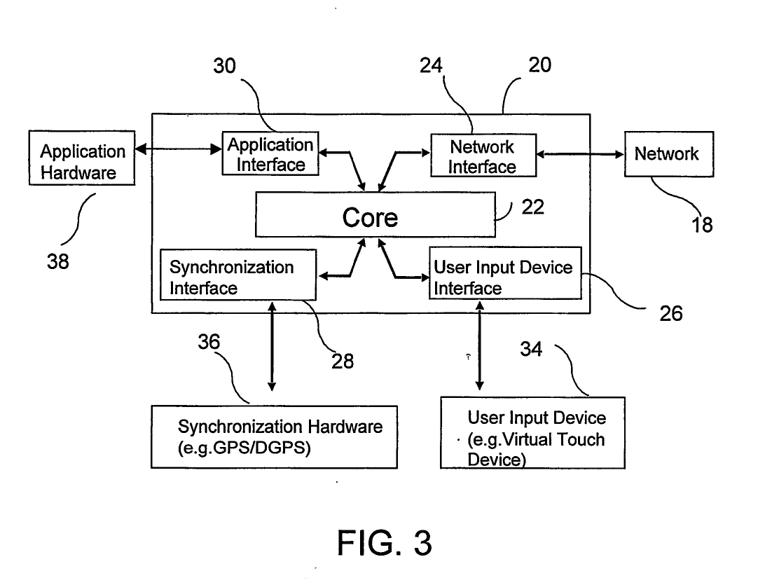

FIG. 3 shows one example of the HRTCC 20. The example of the HRTCC 20 is described in detail in Canadian Application No. 2,363,369, filed on Nov. 21, 2001 in the name of this applicant (which is incorporated herein by reference).

A node in which the HRTCC 20 is installed and which performs a real time control loop to other nodes is referred to as UHRTCC server”. A node which receives the real time control is referred to as “HRTCC client”.

The HRTCC 20 is a platform that integrates real time control capabilities with a user input device 34, a synchronization hardware 36, application hardware 38, and access to a network 18 on the server and/or clients, and is capable of compensating for network time delay.

The HRTCC 20 includes a core 22, a network interface 24, a user input device interface 26, a synchronization interface 28 and an application interface 30.

The network interface 24 facilitates both local and long distance communications. For example, the network interface 24 may include a Bluetooth, Infrared or radio frequency interface for communication to devices, such as cell phones and computer, which is used in the node in which the HRTCC 20 is installed. In addition, the network interface 24 supports long distance communication over local area networks (LANs) (e.g. IEEE 802.11), cellular networks, satellite networks, and FM networks.

The user input device interface 26 facilitates connection of a user input device 34 to the application hardware 38 so that application hardware 38 of either the server HRTCC or the client HRTCC can be controlled. For example, the user input device 34 may include a virtual touch device. The user input device interface 26 supports the virtual touch device which is used in the node to implement open loop or closed loop force effects in a local or networked fashion. The virtual touch device emulates a feeling or sensation generated in the real world. Virtual touch, which involves providing the sense of touch remotely over a network, provides the emulation of force interactions between, for example, a car and the driver of the car in an Automated Highway System (AHS). This provides enhanced safety and security. The same technology is employed for air vehicles (e.g. aircraft, unmanned air vehicles), and sea vehicles (e.g. ships, hovercrafts and submersible crafts).

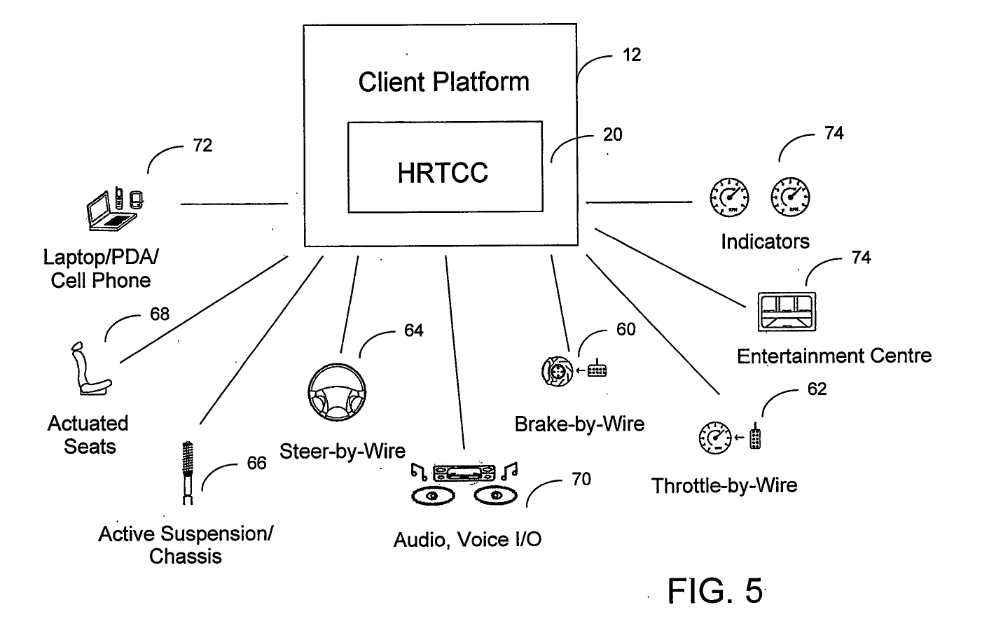

In the automotive application of FIG. 5, the virtual touch device is used to add virtual touch effects to steering wheels, seats, chassis control, drive train control, throttle control, buttons, knobs brakes, suspension systems or any other actuated systems.

The user input device interface 26 may be a microcontroller or microprocessor which takes signals from the core 22 and converts them into a form which can be used by the user input device 34 such as the virtual touch device. The user input device interface 26 also converts signals from the user input device 34 into a form usable by the core 22.

The synchronization interface 28 facilitates connection to synchronizers, such as a GPS receiver, a DGPS receiver, or a Network Time Protocol (NTP) server. In the automotive application, the synchronization interface 28 allows the node, i.e. server 10, client 12, of the HRTCC 20 to obtain its own location on a real time basis using the GPS infrastructure. The interface 28 is also used to pass timing information between the interface 28 and the HRTCC server for synchronization events.

The synchronizer may implement synchronization between the clients and the clients and server using a hardware time source, such as an atomic clock or other high precision hardware time source, a software time source, such as time stamp, NTP, a clock signal provided by the GPS 16 or any of the combination of hardware time sources and software time sources.

The application interface 30 facilitates connection to the application hardware 38, which may not require virtual touch effects. In the automotive application, the application hardware 38 may include windows, door locks, seat positioners, mirror positioners, audio devices, video devices, positioning platforms, under the hood devices, driven train devices and chassis control devices.

The application interface 30 may be a microcontroller or microprocessor which takes signals from the core 22 and converts them into a form which can be used by the actuators on the application hardware 38. The application interface 30 also converts signals from the application hardware 38 into a form usable by the core 22.

The application hardware 38 and the user input device 34 can control each other or can be controlled by each other interactively with or without force feedback via the network 18. Therefore, under a certain circumstance, a HRTCC server can act as a HRTCC client, and vice versa. In FIG. 1, any of the clients 12 can become a HRTCC server, and the server 10 can become a HRTCC client, depending on an application (e.g. automated convoy of a finite number of vehicles or control of multiple Unmanned Vehicles (UVs)).

The interfaces 26-30 also utilize existing standardized Application Programming Interfaces (APIs) or custom interfaces to communicate with off-the-shelf or custom application hardware/software, user input devices and synchronization interfaces.

The interfaces 26-30 may be implemented by any hardware, software or a combination of software and hardware for achieving the above functions.

The core 22 contains hardware (e.g. CPU), software and firmware implemented in a real time operating system (RTOS) to control and manage the real time control loops. The core 22 enables data transfer and real time control between the application hardware 38 and/or the user input device 34, either locally or remotely via the network interface 24. It allows the HRTCC 20 to exchange information over the network 18 and to collect GPS/DGPS in order to synchronize all of the HRTCCs on the network.

The core 22 may also have the functionality of removing time delay effects, which are caused by network latencies caused by signal propagation restrictions, network hardware, number of users, etc. Once all the HRTCCs on the network are synchronized, passive transformation or prediction techniques to remove the time delay effects are employed. The passive transformation technique transforms signals such that the communication channel is seen as passive, while the predictor compensates for the time delay by using an estimator to get clean kinematic (e.g. position, velocity, acceleration, jerk) values, which are then predicted into the future by the same amount of time that was required for the data to be transmitted. The HRTCC 20 accommodates both off the shelf and custom application hardware 38, the user input device 34 (e.g. haptic and non-haptic, custom or off the shelf), a time synchronization capability and the ability to connect to the network 18.

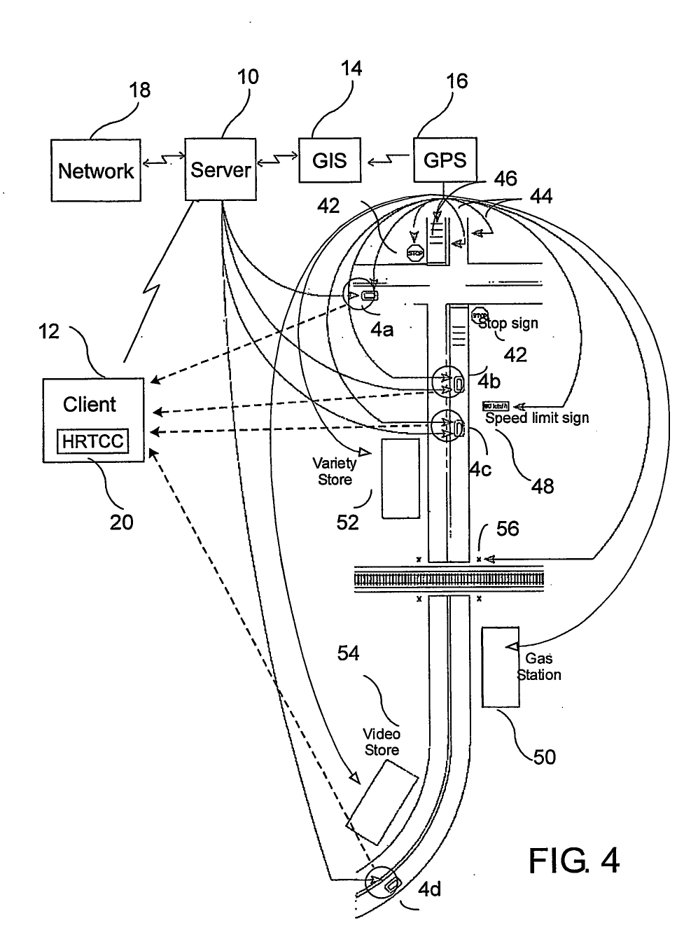

The automotive application of the system 1 is now described in detail. FIG. 4 shows one example of the thin client based intelligent transportation system 1 of FIG. 1. The client 12 is a software/hardware/firmware platform, such as a telematics platform or an embedded microprocessor/microcontroller that includes the HRTCC 20 and is installed in the entity which receives services from the server 10 In FIG. 4, the client 12 is installed in movable entities (e.g. land vehicles) 4a-4d. The client 12 is interfaced to the host vehicle sensors and actuators via wired/wireless means to receive services and implement the control decisions. The server 10 may contain one or more HRTCCs 20.

The GIS 14 contains information on both stationary and moving infrastructure entities. The GPS 16 provides the ability for each of the stationary infrastructure entities' physical properties (e.g. location, perimeter, boundaries) to be identified in the GIS 14. A portable GPS device (not shown) is provided to each of the stationary entities 42-54 to record each entity's location data (e.g. location, boundaries, perimeter, extremities). The GPS 16 forwards the information of stationary infrastructure entities, such as stores 50-54, intersections 44-46, lanes, railway crossings 56, stop signs 42, speed limit signs 48 to be stored as an object in a database of the GIS 14.

Each of the moving infrastructure entities 4a-4d contains a GPS transceiver (not shown) to constantly update its location information. The location information of the moving infrastructure entities is constantly forwarded to the GIS 14 via the server 10 or directly such that the current spatial data is entered into the database of the GIS 14. The server 10 may have a GPS transceiver and compute its location data. The location data of the server 10 may be forwarded to the GIS 14.

The GIS 14 stores the location and properties of all the infrastructure entities. Further, the GIS 14 has functionality to create surfaces and other geometric parameters to describe the characteristics of the infrastructure entity from collected infrastructure information.

For example, the GIS 14 creates a smooth surface from road shoulder information (44) to create a virtual wall. In addition, the GIS 14 may create a surface around the entire vehicle, which is larger than the vehicle itself (referred to as “virtual cocoon”), using information collected from the vehicle on which the client 12 is installed. Intersection of the virtual cocoon and the virtual wall can be used to indicate that warning or control action should be taken to prevent an undesirable interaction between the actual vehicle and the actual shoulder from occurring.

The network 18 provides connection to the server 10 and each of the clients to the outside world for accessing information or communications. Weather information or traffic flow information may be accessed via the network 18. The vehicle's driver may directly use the information obtained from the network 18 or via the server 10. The server 10 may use the information from the network 18 to add additional value to the services provided to the vehicle or the driver.

The server 10 generates the control decisions for active vehicle control (e.g. collision avoidance, performance enhancement, warning systems, dead reckoning, run/update vehicle models for prediction and control purposes). The server 10 coordinates stationary and moving infrastructure information. For example, the server 10 detects infrastructure entities that could interact, and subsequently defines actions/warnings to avoid an unsafe situation. The server 10 may generate the control decisions in consideration of the probability of the occurrence of the unsafe situation. Further, the server 10 processes data for value added services provided to the client including data fusion.

For example, the server 10 inspects weather information/traffic information obtained via the network 18 and the location information on the vehicle 4a and sends control decisions to the client 12 of the vehicle 4a for route guidance, and traffic management.

For example, the server 10 inspects location information on the vehicles and sends control decisions to selected clients 12 for collision warning/avoidance.

For example, it is assumed that the server 10 detects that the “cocoon” of the vehicle 4a intersects the virtual wall of the shoulder 44. In response to the detection, the server 10 sends control decisions to the client 12 of the vehicle 4a to control the steering system of the vehicle 4a. In response to the control decisions, the vehicle 4a may be gently put back on the road defined by the shoulder 44.

Further, the server 10 may have functionality to facilitate inter-client communication. For example, the server 10 creates the connection and passes data from one client to another.

The server 10 may facilitate the client's access to information available on the network. For example, the server 10 makes the connection to the required service on the behalf of the client 12 and off-loads any required computation from the client 12 to allow it to retain its thinness.

FIG. 5 shows a schematic diagram showing one example of device interconnectivity of a host vehicle on which the client is installed. The client 12 of FIG. 5 interfaces to components on the host vehicle, such as sensors, actuators, displays, switches, knobs, onboard electronics, vehicle control devices to enable data requests or control decisions issued by the server 10. The onboard electronics may include an Electronic Control Unit (ECU) within an automobile, Laptop/PDA/cell phone 72, indicators 74, an entertainment centre 76 (e.g. streaming audio/video, game terminal).

To implement the control decisions issued by the server 10, the client 12 may control brake-by-wire systems 60, throttle-by-wire systems 62, steer-by-wire systems 64, active suspension systems 66, or actuated seats 68. For example, the server 10 may implement virtual speed bumps by actuating the seat 68 or the suspension system 66 so that the user in the vehicle feels the virtual speed bumps as if they were real.

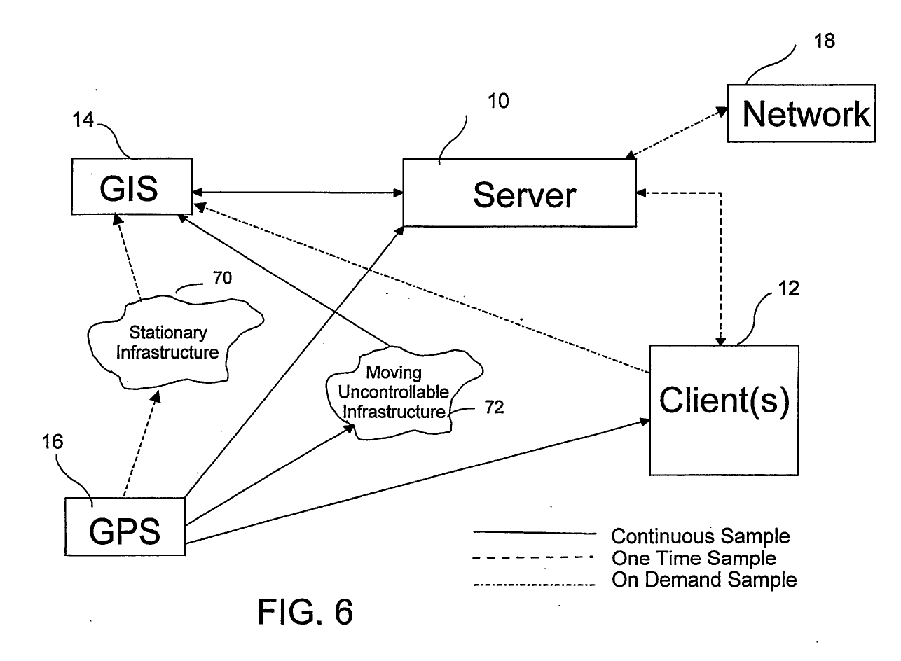

FIG. 6 shows one example of data flow for a sample implementation of the embodiment of the present invention. The server 10 forms a computational engine of the client 12 and is responsible for coordinating the operation of the clients and the associated devices. The server 10 facilitates service to the client 12 using GIS and GPS information and information from the network 18.

The GIS 14 contains a database regarding stationary infrastructure and moving infrastructure. The GPS 16 is used to define information on stationary infrastructure 70 and moving uncontrollable infrastructure 72. The stationary infrastructure 70 and moving uncontrollable infrastructure 72 may have a GPS transceiver to communicate with the GPS 16.

The stationary infrastructure 70 is defined as those objects that typically do not move with respect to the earth's surface. The stationary infrastructure 70 may include roads, signs, intersections, buildings, mountains, towers. The object of the stationary infrastructure 70 is tagged once using the GPS 16 and entered into the GIS 14. For example, the GPS 16 is used to define telemetry/spatial data for the GIS 14 which is subsequently used by the GIS 14 to derive characteristics of the object such as perimeter, volume, etc.

The moving uncontrollable infrastructure 72 is defined as those objects that can move with respect to the earth's surface, but are not controllable by the server 10 or any client 12. The moving uncontrollable infrastructure 72 may include freight, bicycles, motorcycles, animals, people. The GPS 16 is used to provide telemetry information relating to the moving uncontrollable infrastructure 72 on a continuous basis to the GIS 14. Information on the object of the moving uncontrollable infrastructure 72 is updated continuously in the GIS 14 SO that an accurate “map” of the infrastructure is always available. Accurate infrastructure information is one of important factors for applications such at collision avoidance systems.

Information on moving controllable infrastructure (i.e. a vehicle in which the client 12 is installed) is computed by each client 12 using GPS. This information is forwarded to the GIS 14 via the server 10 or directly, when the computation is done by the client 12 or when the GIS 14 requests the server 10 to send this information.

Between the server 10 and the GIS 14, information sampling is done continuously. The GPS 16 provides signals to the server 10 and the client 12 continuously. The signals are processed by the client 12 to generate telemetry/spatial information and, if desired, timing pulses to synchronize devices.

The client 12 may access all services (e.g. information from the GPS 16, information from the GIS 14, information from the network 18, control solution generated based on information from the GIS 14 and GPS 16 and/or information from the network 18) directly or via the server 10.

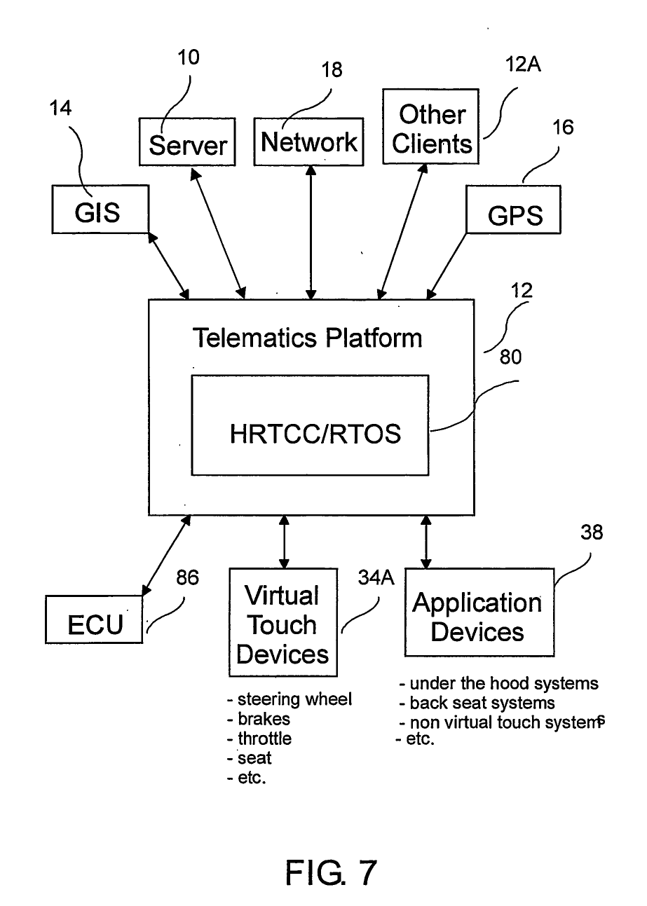

FIG. 7 shows one example of the interconnectivity of the client 12 and other entities within a network from the perspective of the client 12. In FIG. 7, the host hardware of the client 12 is a telematics platform which may be installed in a vehicle. The application is enabled using the HRTCC 20. The internal real time control loop IRTCL and the external real time control loop (ERTCL) are implemented through the real time operating system 80 of the HRTCC 20. Depending on the application, the client 12 utilizes/shares/sends information from/to a variety of service entities including the GIS 14, the server 10, the network 18, the GPS 16, an ECU 86, the virtual touch devices 34A, the application devices 38 and other clients 12A.

In the automotive application, the GIS 14 stores and provides information regarding stationary and moving infrastructure to the client 12. The client 12 may receive this information via the server 10 or a direct connection to the GIS 14. The server 10 provides information on other clients 12A to the client 12. The information on other clients 12A may be used for applications such as an adaptive cruise control system or a collision warning/avoidance system. The network 18 provides the client 12 with information on weather conditions, music/video downloads, reconfigurable dashboard skin download or facilitates communications via cell phones/pages or other networks. The GPS 16 is used to provide location information on the client vehicle, which is used for route guidance, collision warning/avoidance, etc. The information also is used for traffic management.

The automobile's ECU 86 is connectable to the telematics platform and the associated component to provide fully integrated information flow and control. The ECU 86 is an under-the-hood device that is capable of monitoring sensors and controlling devices within the vehicle.

The virtual touch device 34A provides the user with force feedback to emulate an effect or create virtual effects. For example, the virtual touch device 34A is used to provide virtual touch effects to steering wheels, seats, chassis control, drive train control, throttle control, buttons, knobs, brakes, suspension systems or any other actuated systems which are used in the vehicle. The steering wheel of a steer by wire system may employ virtual touch to provide the driver with road feel. Brake by wire systems may be enabled with virtual touch to provide braking feel. A car seat can be used to emulate the sensation caused by virtual speed bumps.

The application device 38 includes any devices that can be controlled but don't require virtual touch effects. The application device 38 may include under the hood systems (e.g. fans, dampers, windows, etc.), front seat services (e.g. route guidance and other location based services), back seat services (entertainment—games, video, audio), seat positioners, door locks, mirror positioners, positioning platforms, drive train devices, chassis control devices.

FIG. 8 shows a schematic diagram of one example of the internal real time control loop (IRTCL). The IRTCL of FIG. 8 is closed on each client and is implemented via the RTOS 80 of the client's HRTCC. In FIG. 8, the vehicle having a client 12B and a device 90, and the vehicle having a client 12C and a device 92 are shown. Appropriate sensor signals from the controlled devices 90 and 92 are piped into the client's HRTCCs. The reference signal from the server 10 is entered into the HRTCC/RTOS 80. The HRTCC/RTOS 80 processes information to generate a control signal. The control signal is sent to the appropriate actuator on each of devices 90, 92. The sensor signal from the device and the control signal from the HRTCC/RTOS 80 are input to the server 10. Depending on the application, reference signals are generated by the client 12B, 12C or the server 10. In addition, sensor and/or control signals may be sent to the server 10 and/or exchanged between clients 12B and 12C. A two-client implementation is shown in FIG. 8. However, the framework of. FIG. 8 is applicable to a multi-client implementation.

The HRTCC/RTOS 80 may run synchronously to control the corresponding device 90 or 92, and communicate with the server 10 asynchronously to receive higher level commands and/or data. The server 10 may communicate with the other services (GIS 14, GPS 16, or other networks) either synchronously or asynchronously depending on the application.

FIG. 9 shows a schematic diagram of one example of the external real time control loop (ERTCL). The ERTCL of FIG. 9 is a control structure characterized by a control loop which includes multiple clients with the control loop being closed through the server 10 and is implemented via the RTOS 80 of the server's HRTCC. Appropriate sensor signals from the devices 90, 92 are processed by the client's HRTCC/RTOS 80 and sent to the server's HRTCC/RTOS 80. A reference signal and the sensor signal are provided to the server's HRTCC/RTOS 80. The server's HRTSS/RTOS 80 generates a control signal. The control signal is processed on the client's HRTCC/RTOS 80 and is used to control the device 90, 92. Depending on the application, reference signals are generated by the server 10 or by one or more of the clients. A two-client implementation is shown in FIG. 9. However, the framework of FIG. 9 is applicable to a multi-client implementation. The server 10 and each client communicate synchronously to control the device attached to the client.

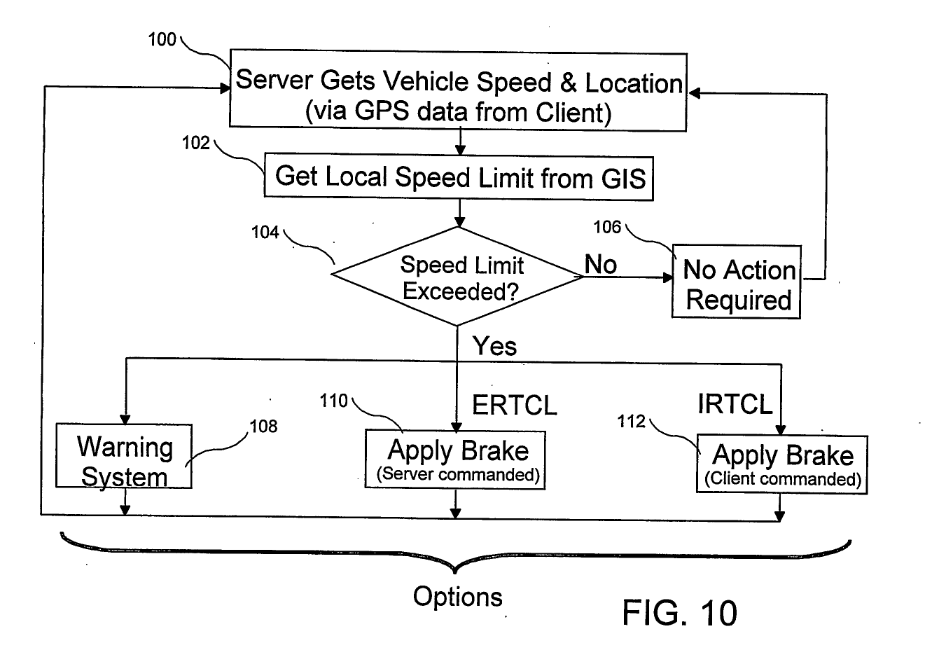

FIG. 10 shows a simplified logic diagram of a thin client based speed limiter for an automobile. The premise here is to limit the speed of an automobile based on the local speed limit.

In step 100, the server 10 obtains the speed and location of the vehicle via the HRTCC client 12 on a continuous basis. In step 102, the server 10 obtains the local speed limit information from the GIS 14. The speed limit may be recorded within the GIS database as stationary infrastructure 70. In step 104, the server 10 examines whether the vehicle speed exceeds the speed limit. If the vehicle's speed is less than the local speed limit, then no action is taken (in step 106) and the process continues from the step 100. If the vehicle's speed is greater than the local speed limit, then one of three steps 108-112 may be taken. In step 108, a warning system is activated, indicating that the speed limit has been exceeded using visual and/or audio and/or haptic cues. The level of warning varies depending on the amount that the speed limit is exceeded. In steps 110-112, command signals are sent to the throttle and/or braking system to reduce the speed of the vehicle to the speed limit.

Step 110 is implemented using the ERTCL methodology. For example, in FIG. 9, each of the clients 12B, 12C is installed in the vehicle. The server 10 generates a control signal for limiting the vehicle speed based on a reference signal (i.e. local speed limit information). The client receives this control signal through the HRTCC/RTOS 80 and controls the corresponding braking system, i.e. device 90 and/or 92. The client provides a sensor signal output from the device (i.e. actual vehicle speed) to the server 10.

The HRTCC/RTOS 80 of the client 12B operates the device 90 or the device 92 of the client 12C and the HRTCC/RTOS 80 of the client 12C operates the device 92 or the device 90 of the client 12B.

Step 112 is implemented using the IRTCL methodology. For example, in FIG. 8, each of the clients 12B, 12C is installed in the vehicle. The server 10 sends a reference signal (i.e. local speed limit information) to the client. The HRTCC/RTOS 80 of the client generates a control signal for limiting the speed of its host vehicle. The client controls the corresponding braking system i.e. device 90 and/or 92 based on this control signal using a control loop local to the client. The client provides a sensor signal output (i.e. actual vehicle speed) from the device and the control signal to the server 10.

The HRTCC/RTOS 80 of the client 12B operates the device 90 or the device 92 of the client 12C and the HRTCC/RTOS 80 of the client 12C operates the device 92 or the device 90 of the client 12B.

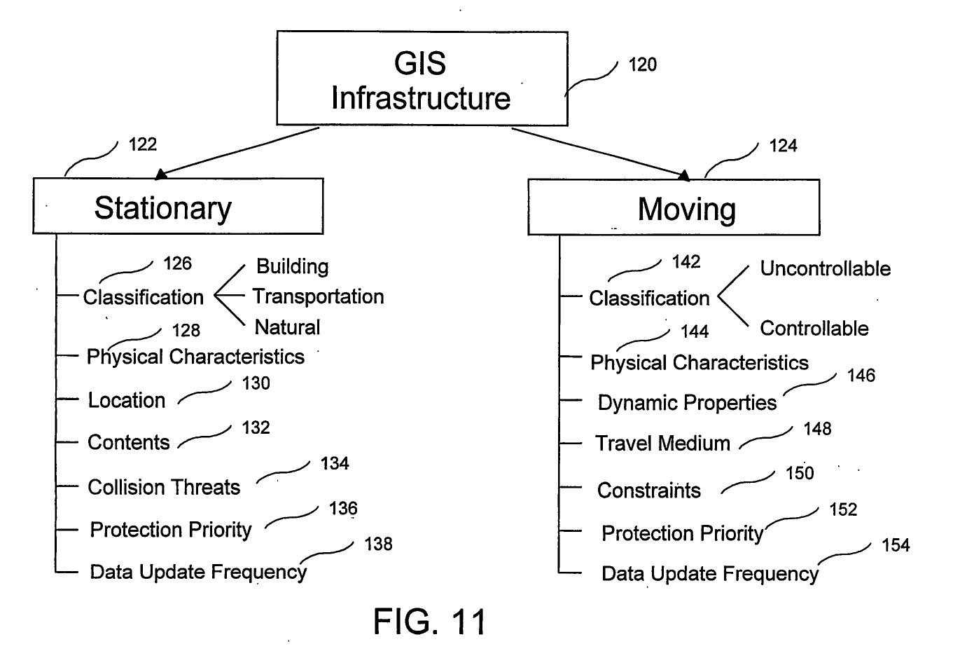

FIG. 11 depicts one example of database structure of the GIS 14 of FIG. 1. The server 10 utilizes the GIS infrastructure to generate information and control decisions. The client 12 also utilizes the database. Infrastructure data is stored within the GIS 14 in an efficient manner to minimise both storage requirements and data access time.

The GIS infrastructure 120 is categorised as stationary” 122 and “moving” 124. The stationary infrastructure may include the fields of classification 126, physical characteristics 128, location 130, contents 134, collision threats 136, protection priority 138 and data update frequency 140. The moving infrastructure may include the fields of classification 142, physical characteristics 144, dynamic properties 146, travel medium 148, constraints 150, protection priority 152 and data update frequency 154.

The classification 126 refers to the type of stationary infrastructure. The classification 126 may include building (e.g. houses, businesses, high rises), transportation (e.g. roads, bridges, signs, lane markers) and natural (e.g. mountains, hills, rivers, lakes, streams).

The physical characteristics 128 refer to the physical quantities that characterize the infrastructure. For example, in the case of a high-rise building, this field might contain sub-fields to identify its perimeter, volume, number of floors, overall height and so on.

The location 130 refers to the location of the building on the surface of the earth in longitude/latitude or expressed in terms of coordinates within a local reference frame.

The contents 132 refer the contents of the infrastructure. For example, an office building is comprised of people whereas a warehouse may contain only product. The content may be defined in conjunction with the protection priority 136 described below.

The field of the collision threats 134 lists those moving controllable or uncontrollable infrastructure objects with which collision with the associated stationary infrastructure is a possibility. A collision probability or priority value may also be defined for each collision threat.

The field of the protection priority 136 defines the level of protection against collision or other threats that should be afforded to the infrastructure object. For example, a higher level of priority should be placed on those infrastructure objects that contain humans (e.g. offices) as opposed to those that contain only material product (e.g. warehouse). This field is defined in conjunction with the contents field.

The data update frequency 138 refers to the rate at which the data associated with the infrastructure object should be updated.

The classification 142 refers to the type of moving infrastructure. The classifications 142 may include controllable infrastructure (e.g. land, sea, or air vehicles) on which the client 12 is installed and uncontrollable infrastructure (e.g. freight, persons, animals).

The physical characteristics 144 refer to the physical quantities that characterize the infrastructure such as volume, surface area, height.

The dynamic properties 146 refer to relevant properties that influence the movement of the infrastructure object such as weight, inertia, the location of the centre of gravity.

The travel medium 148 refers to the medium in which the moving entity primarily travels such as land, sea or air.

The constraints 150 refer to movement constraints applicable to the moving infrastructure. For example, bicycles are constrained to move on the surface of the earth and ships are constrained to move on waterways.

The field of the protection priority 152 defines the level of protection against collision or other threats that should be afforded to the infrastructure object. For example, a higher level of priority should be placed on those infrastructure objects that contain humans (e.g. vehicles) as opposed to those that contain only material product (e.g. unmanned vehicles).

The data update frequency 154 refers to the rate at which the data associated with the infrastructure object should be updated.

According to the thin client premise in a server-client architecture, any application or firmware updates can be uploaded to the server 10. The server 10 subsequently issues whatever information is necessary to each client 12 so that the new version of the application/firmware is integrated immediately.

The thin client premise not only enables a number of value added services (security, safety, & entertainment) throughout the transportation industry (land, sea, & air) but also provides a cost effective alternative to thick client applications across a number of other industries as well (interactive games, process control, interpersonal connectivity, etc.).

Referring to FIG. 1, the applications of the system 1 are now described in further detail. In the automotive industry, the system 1 may be used for the following applications.

Adaptive/Advanced Cruise Control: Existing adaptive cruise controls use a forward-looking sensor (e.g. radar) to detect the distance between moving obstacles. Using the thin client premise in accordance with the embodiment of the present invention, each moving vehicle's data (floating car data) is known via the GPS 16. The moving vehicle's data may include its position and speed. The moving vehicle's data allows the server 10 or one of the clients to have the ability to control the distance and/or speed between the vehicles using a coordinated approach. In the coordinated approach, each client is controlled with the location and status of the other clients taken into consideration.

Traffic Flow Management: When all vehicles on the road are equipped with GPS transceivers, each vehicle's position and speed is known to the server 10. That allows the server 10 to formulate traffic flow solutions, which implement the traffic flow solution via steer by wire, brake by wire, throttle by wire or other remotely controllable subsystems. This results in more efficient traffic flow using a coordinated approach.

Remote Vehicle Takeover: This application gives an individual or a computer the ability to remotely control a vehicle.

Collision Avoidance Systems: Using the thin client model and GPS tagging of mobile and stationary objects, collisions between automobiles, automobiles and persons, automobile and infrastructure, or any other collision are controlled via the server 10. From a virtual touch perspective, vehicles repel each other in a manner similar to magnetic poles using a virtual enclosure, e.g. “cocoon” which encompasses the vehicle. The server 10 takes into account the characteristics of vehicles. For example, the server 10 controls vehicles such that a transport truck does not crush a compact car when the compact car brakes suddenly.

Collision Preparation Systems: In the event of an ensuing collision, the interior of the vehicle is altered to maximize the likelihood of survival of the occupants. The moving vehicle's data is used to detect the impending collision. Subsequently, the server 10 sends control decisions to the client 12 to change seat position and movement characteristics, and alter controllable panels and structures within the vehicle in an effort to place the occupants in the optimal survivability position.

Warning Systems: In this instance, the thin client model enables services that provide users with real time and non real time information to aid in the safe operation of the vehicle. This information is presented via graphical, audio or virtual touch cues only and does not actively control any systems that affect the driving function. The services may include collision detection, path departure notification, weather affected travel ways (e.g. closed highways due to snow or ice).

Active Control Systems: In this instance, the thin client model enables the real time control of systems within the vehicle. For example, the applications include collision avoidance, occupant protection services (in the event of an impending collision), anti-theft systems, automated highway functions (e.g. traffic flow management), remote takeover of vehicles (e.g. hijacked vehicle).

Information Systems: In this instance, the thin client model enables the delivery of non-critical information to the user to make the operation of the vehicle easier or more convenient. For example, the applications include traffic reports, location based services (e.g. locating restaurants, addresses), route guidance and planning, vehicle health monitoring, weather reports, entertainment (video/audio/interactive games).

The thin client model in accordance with the embodiment of the present invention is applicable to any applications whereby an entity or a series of entities is to be steered and/or controlled over a network using a server-client architecture. The examples are as follows.

Land Military Vehicles: The system 1 is used to deploy and control manned and unmanned vehicles, such as tanks, light armoured vehicles, reconnaissance vehicles. Where unmanned vehicles are controlled remotely, virtual touch devices allow the operator of the unmanned vehicle at a remote station to feel the forces that an actual driver of the vehicle would feel during its operation. Using the GIS and GPS capability, vehicles can be steered away from known danger areas such as mine fields and natural hazards.

Manned Aerial Vehicles: Many modern fighter jets and helicopters are adopting a fly by wire strategy, that is, the conduit between the flight controls and the control surfaces are electrical wires transmitting control signals as opposed to cables or mechanical components. The HRTCC 20 is used to add virtual touch to these flight controls. In addition, when these aircrafts are networked, individual aircraft and flight formations are controlled automatically using a thin client premise of the present invention so as to offload the flight path and control calculations to the server 10. In addition, a virtual enclosure (e.g. “cocoon” which encompasses each aircraft) is used to avoid collisions and flight into restricted areas, the latter of which would be defined by geo-fences (e.g. virtual boundaries defined via GPS).

Airborne Vehicles: Air traffic is controlled using the thin client model in which each client 12 is installed in an aircraft and the server 10 coordinates the remote controlled or autonomous motion of each aircraft.

Unmanned Aerial Vehicles (UAVs): The UAVs are made to be small and lightweight, in order to conserve fuel. It is desirable to keep minimal components on board the vehicle. The thin client premise of the present invention allows the UAV to be small and lightweight. In this scenario, the server 10 is located at the base station 8 of FIG. 2.

The real time virtual touch capabilities of the embodiment of the present invention allows an operator at the remote station 8 to feel the forces that an operator in a cockpit would feel, and to remotely operate the aircraft in a realistic manner. In this case, virtual touch devices are provided at the remote station 8, and the HRTCC 20 is installed on the server 10 at the remote station 8 and within the vehicle (client) to support the operation of the virtual touch devices.

In a scenario with multiple UAVs, the server 10 may send control decisions to the UAV such that the operator feels virtual bump when the UAV is approaching another UAV or an obstacle. The system 1 provides a tactile warning for potential collisions. That causes the operator to change the flight path.

Virtual cocoons, each of which encases the UAV, created by the system 1 are also used for controlling the UAVs. When the server 10 detects that two or more virtual cocoons come in contact, the server 10 may cause the UAVs to gently repel each other before actual contact is made. Moreover, virtual touch boundaries may be implemented for geo-fencing applications to enforce no-fly zones to prevent such incidences as collisions of aircraft with buildings.

Further, multiple coordinated UAVs with clients 12, the server 10 and a communication network allows a wider target area to be examined simultaneously. The amount of data processing may be increased. However, Artificial Intelligence (Al) and Vision computational algorithms are done by the server 10 to minimize the computational requirements of the clients 12. The thin client 12 saves on the weight and battery requirements of the UAV. Higher computational costs imply higher current draws by the microprocessor necessitating larger batteries.

In a multi-vehicle coordination, because of the distances involved, sending images and/or telemetry information from the vehicles to the base station 8 and sending commands from the base station 8 to the vehicles involve delays. These can be large delays if satellite communications are employed. However, using the HRTCC 20, the devices on the vehicles are time synchronized and time delays are compensated in the control loop.

Water-Based Surface Vehicles: One of the applications is a water traffic routing system that controls all water traffic in congested areas such as harbours using a network approach. For example, once a ship enters into a predefined region of congestion, the control of its movement reverts to a central server 10. The server 10 is responsible for ensuring safe passage of all water traffic in the congestion area by plotting safe routes and controlling each water vehicle in real time via the client plafform 12 to follow its intended trajectory. The GIS and GPS capability can be used to identify hazards in conjunction with the virtual touch cocoon. That ensures safe passage of vehicles by enunciating a warning or issuing corrective commands to the ship controls to avoid collisions. This approach also provides shipping companies with the capability of controlling fleets of vehicles from a land based console thereby maximizing operational efficiency.

Underwater Vehicles: Underwater vehicles, which are manned or unmanned, are also efficiently controlled through virtual touch enhanced remote controls and virtual touch cocoons.

Telehealth: Rehabilitation or exercise machines can be augmented with virtual touch and networked using the thin client premise. Given the shortage of medical personnel in remote and even highly populated areas and the aging population, the thin client premise allows more patients to be monitored and cared for on a more continuous basis.

Security—Remote Surveillance: Several motorized surveillance devices (e.g. robots, cameras, vehicles, etc.) can be controlled using the thin client premise in accordance with the embodiment of the present invention. Moreover, certain devices can be augmented with virtual touch to allow a remote operator to touch and feel suspicious packages. Virtual touch or haptic cues can also be implemented to restrict motion of the devices at the user input level to increase safety and operational efficiency.

Anti-Terrorism Applications: In the event that a terrorist has taken over a vehicle, the server 10 allows the control of the vehicle to revert to an operator who is stationed in a safe and secure place. The control signals sent to the vehicle are encrypted to prevent further terrorist action. Moreover, knowledge of the motion of the vehicle could be embedded into an encryption mechanism to ensure secure transmission of data.

Interactive Games: The thin client premise of the present invention is also applicable to client-server based interactive games. The game can be run from the server 10 thereby reducing the hardware/software requirements of each client, e.g. Gameboy (trade-mark), PocketPC (trade-mark), PalmPilot (trade-mark), etc. This approach enables real time interactive games including real time interactive virtual touch.

Distributed Collaborative Simulators/Environments: The thin client model of the present invention is applicable for individuals or groups collaborating in a single environment from remote locations. For instance, the US Military has several initiatives ongoing to develop collaborative training environments so that for example a tank division on the West Coast is able to test their strategy against another tank division located elsewhere without having to leave their home bases. The same premise is applicable to other remote training applications such as giving an astronaut located in Fla. the ability to practice on a Canadarm simulator located in Toronto by simply logging onto a training station located at his premises.

In accordance with the embodiment of the present invention, a minimal amount of hardware and intelligence is installed in the vehicle. Moreover, the performance of applications can be improved due to access to global information. For example, global weather conditions/forecasts can be used for route guidance purposes to avoid storms and disturbances to ensure that the vehicle travels in such a fashion as to maximize safety and operational efficiency. Other aspects associated with the embodiment of the present invention are as follows:

Cost Reduction—The thin client premise is based on minimising the hardware, software & embedded intelligence requirements at the client level which translates to cost reduction in both the short term and long term.

Performance—A server-client model that has access to global information regarding infrastructure and the motion of other clients can result in enhanced application safety and performance.

Reconfigurability—The user is able to download, from the server, preferences, skins, etc. relating to the operation of specific devices to suit their needs.

Ubiquity—Use of the GPS and associated GIS's means active content anywhere in the world.

Life Cycle Mismatch Mitigation—Minimisation of the thin client based intelligence and hardware, which typically has a shorter lifetime than the platform on which it is installed (e.g. automobile), translates to fewer hardware upgrades on the client side and thus reduced costs.

Expandability—The thin client premise readily supports a number of other applications and features as well as the seamless addition to/removal of clients from the network.

The HRTCC 20 may be implemented by any hardware, software or a combination of hardware and software having the above described functions. The GPS 16 and the GIS 14 may be implemented by any hardware, software or a combination of hardware and software having the above described functions. The software code, either in its entirely or a part thereof, may be stored in a computer readable memory. Further, a computer data signal representing the software code which may be embedded in a carrier wave may be transmitted via communication network. Such a computer readable memory and a computer data signal are also within the scope of the present invention, as well as the hardware, software and the combination thereof.

While this invention has been described with reference to several specific embodiments, the description is illustrative of the invention and is not to be construed as limiting the invention. Various modifications and variations may occur to those skilled in the art without departing from the true spirit and scope of the invention as defined by the appended claims.

1-69. (canceled)

70. An intelligent thin client system comprising:
a server coordinating data flow and functionality of a data network, the server being a host for application software;
a plurality of thin clients, the thin client implementing a control decision generated by the server on a device to which it is connected; and
a communication network for interconnecting the system and services;
the thin client and/or the server including a platform, the platform integrating real time control of components of the thin clients or the server and the thin client.

71. The system according to claim 70, further comprising a positioning system for providing a mechanism to allow the thin clients to compute location data.

72. The system according to claim 71, wherein the thin client is installed on a movable entity, the server generating the control decision based on the location data of the movable entity, information obtained through the network or integration of the location data and the information.

73. The system according to claim 71, further comprising an information system providing data on geographic infrastructure, the positioning system providing a mechanism by which an infrastructure containing the system is identified by the information system.

74. The system according to claim 73, wherein the information system has a database for storing geographical information on stationary infrastructure and moving infrastructure, the moving infrastructure including location data of a movable entity operatively communicating with the thin client, the server or a combination thereof.

75. The system according to claim 74, wherein the information system creates a virtual object, which includes an enclosure encompassing the movable entity, and the server generates the control decision based on the virtual object.

76. The system according to claim 74, wherein the server generates the control decision based on information obtained through the network, characteristics of the infrastructure identified by the information system, or an integration of the information obtained through the network and the information provided by the information system.

77. The system according to claim 70, wherein any one of the platforms of the thin clients acts as a platform server, which has ability of operating the remaining platforms remotely.

78. The system according to claim 70, wherein the thin client is installed on an entity which includes a virtual touch device, the server generating the control decision to operate the virtual touch device.

79. The system according to claim 78, wherein the virtual touch device is used to control, with a virtual touch sensation, a remote device to reflect forces felt by the device.

80. The system according to claim 70, wherein the platform implements an internal real time control loop (IRTCL) which is closed on the thin client.

81. The system according to claim 80, wherein the server provides a reference signal to the thin client, the platform of the thin client, which receives the reference signal, generating a control signal to operate the device.

82. The system according to claim 81, wherein the server provides the reference signal based on the information obtained through the network.

83. The system according to claim 70, wherein the platform implements an external real time control loop (ERTCL) which is closed between two or more thin clients through the server.

84. The system according to claim 83, wherein the server provides the control signal based on a reference signal obtained through the network.

85. The system according to claim 70, wherein the platform obtains a feedback signal from the device, the thin client providing the feedback signal to the server.

86. The system according to claim 70, wherein the platform is a hard real time platform which is capable of implementing real time control loops, the hard real time platform including a synchronization hardware interface for facilitating synchronization of the platforms, a user input device interface for facilitating connection of a user input device to an application hardware and an application interface for facilitating connection to the application hardware, and a core for controlling and managing the real time control loops.

87. The system according to claim 70, wherein the platform is implemented by hardware, software or a combination of the hardware and the software.

88. The system according to claim 70, wherein the platform includes a synchronizer for synchronizing events.

89. The system according to claim 88, wherein the synchronizer implements the synchronization using information obtained through the network, a clock pulse provided by a global positioning system (GPS), a software time source, a hardware time source, a network time protocol (NTP), an atomic clock or combinations thereof.

90. The system according to claim 70, wherein the platform compensates for network time delay.

91. A method for an intelligent thin client system, the system including a server coordinating data flow and functionality of a data network, a plurality of thin clients, and a communication network for interconnecting the system and services, the thin client and/or the server including a platform, the method comprising the steps of:
establishing synchronization between the thin clients or the thin client and the server;
in the server, generating a control decision and providing the control decision to the thin client;
implementing the control decision on a device to which the system is connected using the platform; and
in the platform, integrating real time control of components of the thin clients or the server and the thin client.

92. A method according to claim 91, further comprising the steps of:
obtaining information through the network attached to the server, and providing services based on the information to the thin client.

93. A method according to claim 92, wherein the step of establishing synchronization includes the step of establishing the synchronization using information obtained through the network, information provided by a global positioning system (GPS), a software time source, a hardware time source, or combinations thereof.

94. A method according to claim 91, further including the steps of:
computing location, telemetry, or spatial data of an entity on which the platform is installed, and
providing the computation result to the server.

95. A method according to claim 94, further including the step of:
providing signals through the network to the thin clients to enable the computation.

96. A method according to claim 94, wherein the step of generating a control decision includes the step of:
generating a control decision based on the computation results obtained from the thin client, the information obtained through the network or an integration of the computation results and the information obtained through the network.

97. A method according to claim 91, wherein the step of implementing the control decision includes the step of:
implementing an internal real time control loop (IRTCL) which is closed on the thin client.

98. A method according to claim 97, wherein:
the step of generating a control decision includes the step of providing a reference signal to the thin client, and
the step of implementing an IRTCL includes the step of generating a control signal based on the reference signal in the platform to operate the device.

99. A method according to claim 98, wherein the step of generating a control decision includes the steps of:
obtaining information through the network, and
providing the reference signal based on the information obtained through the network.

100. A method according to claim 91, wherein the step of implementing the control decision includes the step of implementing an external real time control loop (ERTCL) which is closed between two or more thin clients through the server.

101. A method according to claim 100, wherein the step of generating a control decision includes the steps of:
obtaining a reference signal through the network, and providing the
control signal based on the reference signal obtained through the network.

102. A method according to claim 100, wherein the step of implementing the control decision includes the step of:
operating, with a virtual touch sensation based on the control decision, a remote device to reflect forces felt by the device.

103. A method according to claim 91, wherein the client is installed on a vehicle, the step of generating a control decision including the steps of:
obtaining speed and location of the vehicle,
obtaining a local speed limit information on the location through the network, and
comparing the local speed limit with the speed of the vehicle.

104. A method according to claim 103, wherein the step of generating a control decision includes at least one of the following steps:
generating a control signal to operate the device of the vehicle to limit the speed of the vehicle within the speed limit,
generating a control signal for activating a warning system of the vehicle to provide a warning to a user of the vehicle.

105. A method of according to claim 104, wherein the step of implementing the control decision includes the step of:
obtaining a sensor signal from the device, and
providing the sensor signal to the server.

106. A method according to claim 91, wherein the step of generating a control decision includes the step of:
obtaining information through the network, and
providing the control signal based on the information obtained through the network.

107. A method according to claim 91, wherein the step of implementing the control decision includes the step of:
obtaining a feedback signal from the device and the step of providing the feedback signal to the server.

108. A method according to claim 91, further comprising the step of compensating for network delay in the platform.
